(19) United States
(12) Patent Application Publication
(10) Pub. No.: US 2010/0210146 A1
(43) Pub. Date: Aug. 19, 2010

(54) LEAD CONNECTOR END AND METHOD OF MANUFACTURE

(75) Inventors: Grace Jang, Calabasas, CA (US); Benedict L. Gomperz, North Hollywood, CA (US)

Correspondence Address: PACESETTER, INC., 15900 VALLEY VIEW COURT, SYLMAR, CA, 91392-9221, US

(73) Assignee: PACESETTER, INC., Sylmar, CA (US)

(21) Appl. No.: 12/388,046

(22) Filed: Feb. 18, 2009

(51) Int. Cl. H01R 31/00; B29C 45/14

(52) U.S. Cl. 439/638; 264/275

(57) ABSTRACT

A method of manufacturing a lead connector end of an implantable medical lead is disclosed herein. The method may include: provide a mold cavity including a feature and a longitudinal axis; place a ring contact in the mold cavity, engage the ring contact with the feature; fill the mold cavity with a mold material, the feature preventing displacement of the ring contact along the longitudinal axis; allow the mold material to cure; remove a resulting lead connector end from the mold cavity; and reduce an excessive diameter of the resulting lead connector end to a finished diameter.

### FIELD OF THE INVENTION

The present invention relates to medical apparatus and methods. More specifically, the present invention relates to implantable medical leads and methods of manufacturing such leads.

### BACKGROUND OF THE INVENTION

An implantable medical lead typically includes one or more lead connector ends on the proximal end of the lead. The lead connector ends are used to mechanically and electrically couple the lead proximal end to the header or connector bores of a pacemaker, implantable cardioverter defibrillator (“ICD”) or other type of pulse generator.

An IS4/DF4 lead connector end is a type of lead connector end that combines the features of multiple lead connector ends into a single multi-polar lead connector end. The seals for common lead connection systems have historically been integral to the lead connector end rather than to the header or connector bore of a pulse generator to be coupled to a lead. In contrast, the IS4/DF4 connection system standards require the seals to be integral to the header or connector bore of the pulse generator. While a certain degree of dimensional accuracy is needed for many types of lead connector ends, the IS4/DF4 seal arrangement further increases the need for dimensional accuracy for the IS4/DF4 lead connector end. For example, the IS4/DF4 seal arrangement necessitates tightly controlled dimensional stability of the relative location of the contact rings of the IS4/DF4 lead connector end.

The industry standard approach of insert molding the contact rings into the polymer material forming a lead connector end body is challenged by the resultant variability of the contact ring location along the axial length of the lead connector end body, the variability of the resultant diameter of the contact rings relative to the seal zones in between the contact rings, and the variability of the diameter of the seal zones themselves due to the uncontrollable variability of the shrink of the polymer material forming the lead connector end body.

Tight tolerances are required for the safe and effective performance of typical lead connector systems, and this is especially the case with respect to the IS4/DF4 connector system. The impact of maintaining such tight tolerances in a production environment can be unacceptable due to the high product cost of the lead connector end and poor manufacturing yields.

There is a need in the art for a lead connector end and method of manufacturing such a lead connector end that addresses the above-mentioned issues.

### BRIEF SUMMARY OF THE INVENTION

A method of manufacturing a lead connector end of an implantable medical lead is disclosed herein. In one embodiment, the method includes: provide a mold cavity including a feature and a longitudinal axis; place a ring contact in the mold cavity, engaging the ring contact with the feature; fill the mold cavity with a mold material, the feature preventing displacement of the ring contact along the longitudinal axis; allow the mold material to cure; remove a resulting lead connector end from the mold cavity; and reduce an excessive diameter of the resulting lead connector end to a finished diameter.

Another method of manufacturing a lead connector end of an implantable medical lead is disclosed herein. In one embodiment, the method includes: provide a ring contact in a mold cavity including a longitudinal axis, the ring contact including an excessive outside diameter that exceeds a finished outside diameter of the lead connector in a finished state; fill the mold cavity with a mold material, wherein the excessive outside diameter prevents the ring contact from displacing along the longitudinal axis during the filling of the mold cavity; allow the mold material to cure, resulting in a resulting lead connector end; remove the resulting lead connector end from the mold cavity; and subject the resulting lead connector end to a process wherein the excessive outside diameter is reduced to the finished outside diameter.

Also disclosed herein is a lead connector end for an implantable medical lead, wherein the lead connector end is manufactured according to any of the embodiments disclosed herein. For example, in one embodiment, the lead connector end includes a cylindrical outer surface including seal region surfaces separating ring contact surfaces in a spaced apart arrangement, the ring contact surfaces being the result of a centerless grinding process. The spaced apart arrangement may be the result of a molding process wherein ring contacts corresponding to the ring contact surfaces are secured from displacing along a longitudinal axis of a mold cavity during injection of a mold material corresponding to the seal region surfaces.

While multiple embodiments are disclosed, still other embodiments of the present invention will become apparent to those skilled in the art from the following Detailed Description, which shows and describes illustrative embodiments of the invention. As will be realized, the invention is capable of modifications in various aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a side view of an electrophysiology device and, more specifically, an implantable medical lead.

FIG. 2 is a side view of the lead connector end extending proximally from a proximal end 14 of the lead body 12.

FIG. 3 is an isometric view of the lead connector end of FIG. 2, less the proximal end of the lead body and showing the conductors that extend through the lead body from the lead connector end.

FIG. 4 is a process flow chart generally outlining the method of manufacture.

FIG. 5 is diagrammatic depiction of a mold cavity and oversized ring contacts employed in the method of manufacture.

FIG. 6 is an isometric view of the resulting oversized lead connector end with the material filled runners leading thereto.

FIG. 7 is a side view of the oversized lead connector end free of the material filled runners depicted in FIG. 7.

FIG. 8 is an isometric view of the resulting oversized lead connector less the material filled runners.

### DETAILED DESCRIPTION

A lead connector end 18 and a method of manufacturing such a lead connector end 18 are disclosed herein. The lead connector end 18 compensates for or eliminates the sources of dimensional variability often found in lead connector ends commonly found in the art, resulting in high quality production lead connector ends produced at minimal cost.

In one embodiment, the lead connector end 18 is manufactured via a molding process wherein the ring contacts 2 are prevented from displacing along the longitudinal axis LA of the mold cavity during an injection molding process. For example, in one embodiment of the manufacturing process, a mold cavity 40 is provided, wherein the mold cavity 40 includes a longitudinal axis LA and a feature 44, such as for example, an arcuate recess 44 defined in a surface 42 of the mold cavity 40 and extending in a plane generally transverse or perpendicular to the longitudinal axis LA. An oversized ring contact 2′ having an oversized outside diameter DR′ that exceeds the finished outside diameter DR of the finished lead connector end 18 is placed in the mold cavity 40 and, more specifically, received in the arcuate recess 44 such that the arcuate recess 44 engages the oversized ring contact 2′. The mold cavity 40 is filled with a mold material, such as, for example, a polymer. The mold cavity filling process may be accomplished via a high pressure injection molding process. The oversized ring contact 2′ being engaged by the arcuate recess 44 prevents the oversized ring contact 2′ from displacing along the longitudinal axis of the mold cavity 40 during the high pressure injection molding process. The mold material is allowed to cure, and the resulting lead connector end 18′ is removed from the mold cavity 40. The resulting lead connector end 18′ is then subjected to a process that reduces the oversized outside diameter DR′ of the oversized ring contacts 2′ to the finished outside diameter DR of the finished ring contacts 2, resulting in a finished lead connector end 18 having a generally isodiametric configuration. In one embodiment, the process for reducing the oversized outside diameter DR′ may be a centerless grinding process.

The following description presents preferred embodiments of the lead connector end 18 and its method of manufacture and represents the best mode contemplated for practicing the lead connector end 18 and its method of manufacture. This description is not to be taken in a limiting sense, but is made merely for the purpose of describing the general principles of the lead connector end 18 and it method of manufacture, the scope of both being defined by the appended claims.

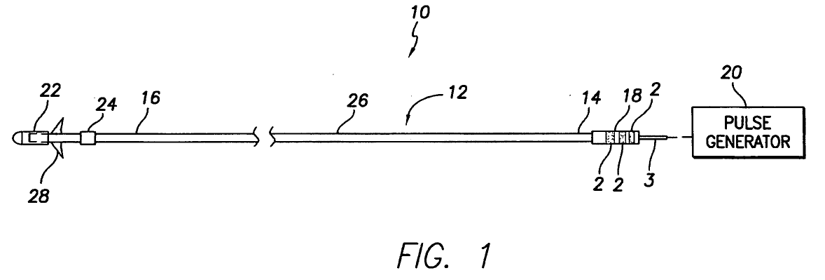

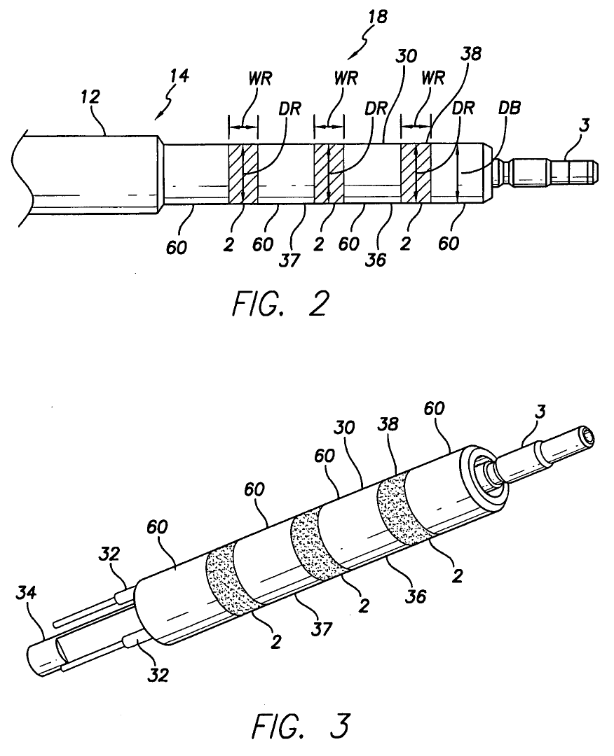

FIG. 1 is a side view of an implantable medical lead 10, which may be any type of an implantable medical lead 10, including, for example, a bradycardia, tachycardia, RV, LV or other type of lead. As shown in FIG. 1, the lead 10 includes a tubular body 12 having a proximal end portion 14 and a distal end portion 16. The proximal end portion 14 of the tubular body 12 carries a connector assembly 18 for coupling the tubular body 12 to a receptacle on a pulse generator 20 such as, for example, a pacemaker or an ICD. Depending on its type, the lead connector end 18 may include one or more ring contacts 2 and a pin contact 3, the contacts 2, 3 contacting complementary contacts in the pulse generator 20 when the lead connector end 18 is received in the pulse generator 20. For example and as discussed with respect to FIG. 2 below, when the lead connector end 18 is an IS4/DF4 lead connector end 18, there may be three ring contacts 2 and a pin contact 3.

The distal end portion 16 of the tubular body 12 carries a tip electrode 22 and a ring electrode 24 proximal of the tip electrode and spaced apart therefrom. The ring electrode 24 may serve as a pacing/sensing electrode, although it will be evident that it may instead function as a cardioverting and/or defibrillating electrode. While the lead 10 depicted in FIG. 1 is depicted as a passive fixation lead, in other embodiments, the lead 10 may be configured for active fixation, even being equipped at the distal end with a helix anchor or other type of active fixation feature.

The tubular body 12 may be adapted to transmit stimulating and/or sensed electrical signals between the connector assembly 18, on the one hand, and the tip and the ring electrodes 22 and 24, on the other. For example, the tubular body 12 may have one or more conductors (e.g., cable conductors, helical conductors, etc.) longitudinally extending through the tubular body 12 between a contact 2, 3 and a respective electrode 22, 24, thereby placing the contact 2, 3 and respective electrode 22, 24 in electrical communication.

By way of example and not limitation, the distal end portion 16 of the tubular body 12 of the lead 10 may have a diameter of about 0.026 inch (2F) to about 0.131 inch (10F), with a diameter of about 0.079 (6F) being preferred, and the ring electrode 24, where it serves a sensing function, may have a diameter of about 0.079 inch (6F) and a length of about 0.100 inch. The tubular body 12 may include a tubular insulating sheath or housing 26 of a suitable insulative biocompatible biostable material such as, for example, silicone rubber, polyurethane, silicone rubber-polyurethane-copolymer (“SPC”) or other suitable elastomer, extending the entire length of the tubular body 12.

The housing 26 may include along the distal end portion of the lead a plurality of rearwardly projecting tines 28 functioning, as is well know in the art, to interlock in the trabeculae within the heart and thereby prevent displacement of the distal end portion 16 once the lead 10 is implanted. Although tines are the preferred anchoring features for purposes of the present lead 10, it will be understood by those skilled in the art that fins, a screw-in helix, or some other suitable active fixation anchoring features may be used instead. Also, the lead may be configured for passive fixation via, for example, one or more S-shaped bends in the tubular body 12 along the distal end portion, and may be without tines or active fixation features. The S-shaped bends may bias against the walls of the coronary sinus region to maintain the lead 10 in position.

For a detailed discussion regarding the configuration of a lead connector end 18, which for the sake of the following description may be an IS4/DF4 lead connector end 18, reference is made to FIGS. 2 and 3. FIG. 2 is a side view of the lead connector end 18 extending proximally from a proximal end 14 of the lead body 12, and FIG. 3 is an isometric view of the lead connector end 18 of FIG. 2, less the proximal end 14 of the lead body 12 and showing the conductors 32, 34 that extend through the lead body 12 from the lead connector end 18. While the lead connector end 18 and its method of manufacture are discussed in the following description in the context of an IS4/DF4 lead connector end 18, the novel features of the lead connector end 18 and its method of manufacture are equally applicable to other types of lead connector ends. Accordingly, the lead connector end features and method of manufacture should not be limited to IS4/DF4 lead connector ends, but should be interpreted to be applicable to other types of lead connector ends and their manufacture.

As shown in FIG. 2, the IS4/DF4 lead connector end 18 may have three ring contacts 2, a pin contact 3 and a connector body 30. The connector body 30 may be formed of an electrically non-conductive polymer material (e.g., tecothane, polyetheretherketone (“PEEK”), polysulfone, etc.) or other type of electrically non-conductive material. The ring contacts 2 may be located along the connector body 30 in a spaced-apart fashion along the longitudinal length of the connector body 30. The pin contact 3 may extend proximally from the proximal end 32 of the connector body 30, and the connector body 30 may extend proximally from the proximal end 14 of the lead tubular body 12.

As can be understood from FIG. 3, a cable conductor 32 may extend distally through the connector body 30 from each respective ring contact 2. A helical conductor 34, which may define a central lumen that extends into a central lumen of the pin contact 3, may extend distally through the connector body 30 from the pin contact 3.

As indicated in FIGS. 2 and 3, the connector body 30 may have a generally uniform and isodiametric cylindrical configuration. Thus, the outside diameters DR of the ring contacts 2 and the outside diameter DB of the connector body 30 may be equal to each other along the lengths of their entire circumferential surfaces and correspond to the outside diameter of the particular connector standard, which in this example is the IS4/DF4 standard. The ring contacts 2 may be generally imbedded in the material of the connector body 30 or otherwise carried on the connector body 30 in such a manner that the lead connector end's outer circumferential surface 36, which may be formed of the combined outer circumferential surfaces 37, 38 of the connector body 30 and the contact rings 2, may be a generally uniform and isodiametric cylindrical configuration.

The lead connector end 18 is manufactured to have tight tolerances with respect to the location of the ring contacts 2 and the spacing between the contact rings 2. The lead connector end 18 is also manufactured to have tight tolerances with respect to the diameter and constant and uniform isodiametric cylindrical configuration of the lead connector end 18. These tight tolerances provide a lead connector end 18 with a consistent, smooth cylindrical surface that can be used to create a high voltage seal between adjacent electrical contacts and meet the IS4/DF4 outside diameter dimensional requirements. Also, the tight tolerances provide a lead connector end 18 with consistent, appropriate ring contact location and spacing.

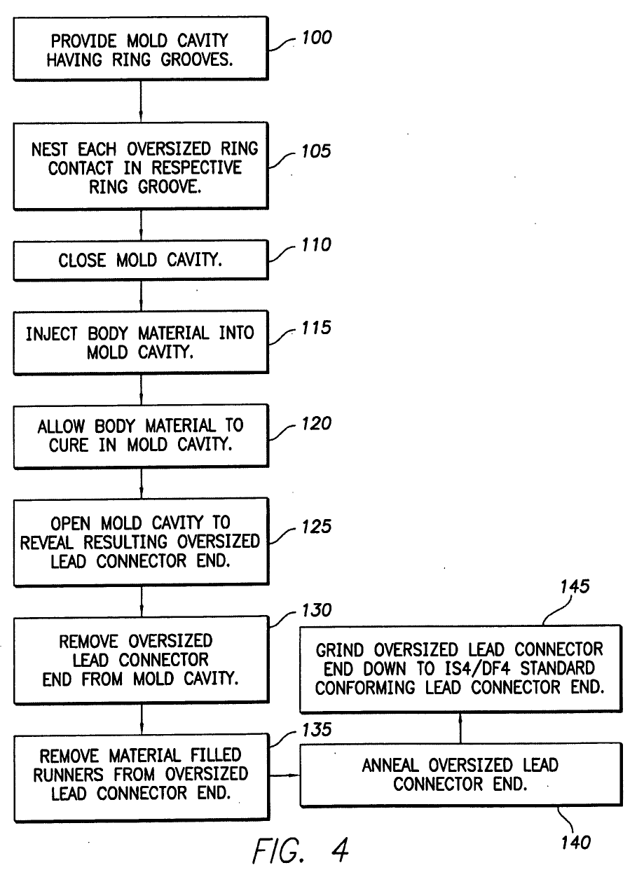

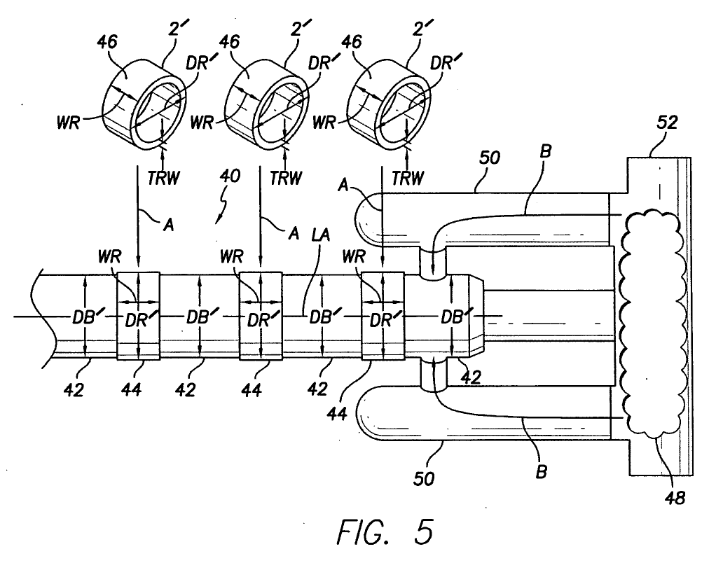

For a discussion of a method of manufacturing the lead connector end 18, reference is made to FIGS. 4 and 5. FIG. 4 is a process flow chart generally outlining the method of manufacture, and FIG. 5 is diagrammatic depiction of a mold 40 and oversized ring contacts 2′ employed in the method of manufacture.

As indicated in FIGS. 4 and 5, a grooved mold cavity 40 may be provided [block 100 of FIG. 4]. The grooved mold cavity 40 may include a circumferential surface 42 that may correspond to a circumferential surface 36 of the lead connector end body 30. Ring grooves 44 are defined in the circumferential surface 42, wherein the circumferential surfaces of the ring grooves 44 correspond to the circumferential surfaces 46 of the oversized ring contacts 2′ in outside diameter DR′ and surface width WR.

In one embodiment, the circumferential surface 42 may be precisely machined into the mold cavity 40 to precisely match the diameter DB, shape and surface condition of the lead connector body 30 of the particular connector standard, which in this example is the IS4/DF4 standard. In another embodiment, the circumferential surface 42 may be precisely machined into the mold cavity 40 to precisely match a diameter DB′ and shape that is oversized a predetermined extent to allow a machining process (e.g., grinding, etc.) to reduce the molded diameter DB′, shape and surface condition of the resulting molded lead connector body 30′ to diameter DB, shape and surface condition of the lead connector end body 30 of the particular connector standard, which in this example is the IS4/DF4 standard.

The ring grooves 44 may be machined precisely into the circumferential surface 42 of the mold cavity 40. Except with respect to having a diameter DR′ that corresponds to the excessive diameter DR′ of the oversized ring contacts 2′, the surface width WR, axial location, orientation, and axial spacing of the ring grooves 44 precisely match the requirements of the particular connector standard, which in this example, is the IS4/DF4 standard.

In one embodiment, the oversized ring contacts 2′ may have a ring wall thickness TRW (see FIG. 5) that exceeds the ring wall thickness of the ring contacts 2 of the finished lead connector end 18. In one embodiment, the ring wall thickness TRW of the oversized ring contacts 2′ may exceed the ring wall thickness of the finished ring contacts 2 by between approximately 0.15 mm and approximately 0.25 mm.

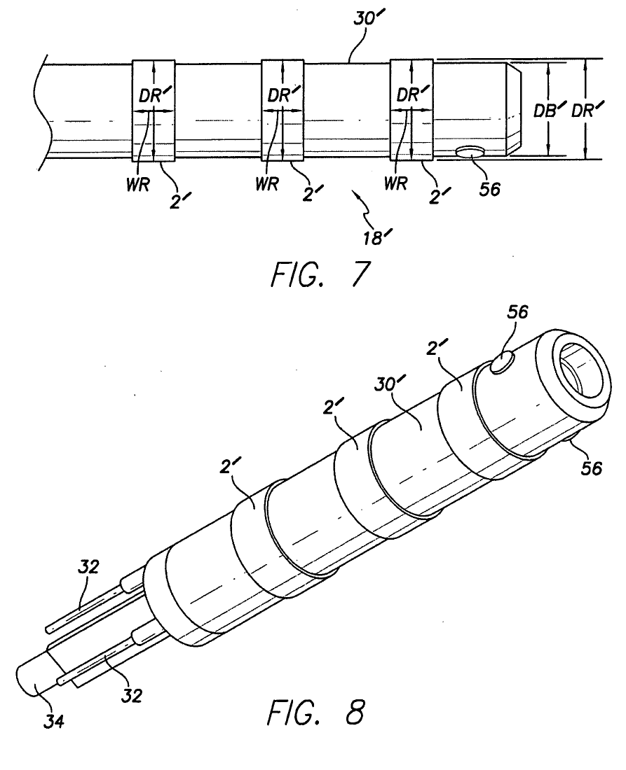

In one embodiment, the oversized ring contacts 2′ may have an outside diameter DR′ (see FIGS. 4 and 7) that exceeds the outside diameter DR (see FIG. 2) of the ring contacts 2 of the finished lead connector end 18. In one embodiment, the outside diameter DR′ of the oversized ring contacts 2′ may exceed the outside diameter DR of the finished ring contacts 2 by between approximately 0.45 mm and approximately 0.35 mm. In one embodiment, the ring contacts 2 are formed of a metal such as, for example, platinum, platinum-iridium alloy, MP35N, stainless steel, etc.

As indicated in FIG. 5 by each arrow A, the oversized ring contacts 2′ are each nested in a respective ring groove 44 [block 105 of FIG. 4], and the mold cavity 40 is closed [block 110 of FIG. 4]. As a result, the ring grooves 44 securely hold the oversized ring contacts 2′ precisely in place within the mold cavity 40 such that the location, orientation and spacing of the oversized ring contacts 2′ precisely correspond to the IS4/DF4 standard. As indicated by each arrow B, the body material 48 (e.g., PEEK, techothane, polysulfone, etc.) that forms the connector body 30 is injected into the mold cavity 40 via runners 50 extending from the injection machine 52 [block 115 of FIG. 4].

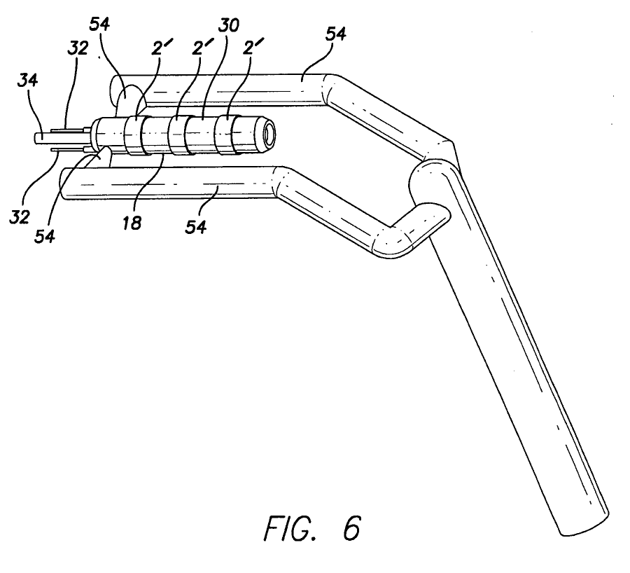

As can be understood from FIGS. 6 and 7, which are, respectively, an isometric view of the resulting oversized lead connector end 18′ with the material filled runners 54 leading thereto and a side view of the oversized lead connector end 18′ free of the material filled runners 54, the body material 48 is allowed to cure [block 120 of FIG. 4]. The ring grooves 44 of the mold cavity 40 prevent the oversized ring contacts 2′ from displacing during the high pressure injection of the material 48, thereby maintaining the location, orientation and spacing of the oversized contact rings 2′ in conformance with the IS4/DF4 standards during the high pressure injection molding process and the subsequent curing process.

The mold cavity 40 is opened to reveal the resulting oversized lead connector end 18′ [block 125 of FIG. 4]. The oversized lead connector end 18′ is removed from the mold cavity 40 [block 130 of FIG. 4]. As indicated in FIG. 6, the resulting oversized lead connector end 18′ may have an oversized connector body 30′ with oversized ring contacts 2′ imbedded therein, conductors 32, 34 extending proximally therefrom, and material filled runners 54 extending from the sides of the oversized connector body 30′.

For a discussion of the next step, reference is made to FIGS. 7 and 8, wherein FIG. 8 is an isometric view of the resulting oversized lead connector 18′ less the material filled runners 54. As shown in FIGS. 7 and 8, the material filled runners 54 are cut or otherwise removed from the oversized connector body 30′ [block 135 of FIG. 4]. The removal of the material filled runners 54 may leave residual runner bumps 56 as shown in FIGS. 7 and 8.

As can be understood from FIG. 7, for the resulting oversized lead connector end 18′, the outside diameter DR′ of the oversized ring contacts 2′ may exceed the outside diameter DB′ of the oversized connector body 30′. In one embodiment, for the resulting oversized lead connector end 18′, the oversized outside ring diameter DR′ may exceed the oversized outside body diameter DB′ by between approximately 0.1 mm and approximately 0.3 mm.

The oversized lead connector 18′ may be annealed [block 140 of FIG. 4]. The oversized lead connector 18′ may then be subjected to a centerless grind process or other machining process to reduce the respective oversized outside diameters DR′, DB′ of the oversized ring contacts 2′ and oversized contact body 30′ to the respective outside diameters DR, DF of the IS4/DF4 standard [block 145 of FIG. 4]. Subsequent to the machining process [block 145], the lead connector end 18 will now conform to the IS4/DF4. The pin contact 3 is then installed in the proximal end of the lead IS4/DF4 standard conforming lead connector end depicted in FIGS. 2 and 3. As can be understood from FIGS. 2 and 3, the respective outside diameters DR, DF may be equal such that the lead connector end 18 has a continuously isodiametric cylindrical shape. The diameters and lengths of the seal regions 60 meet the IS4/DF4 standards, and the axial locations, orientations, axial spacing and diameters of the ring contacts 2 meet the IS4/DF4 standards.

The above-described manufacture method provides lead connector ends 18 having tight tolerances conforming to a desired standard, such as, for example, the IS4/DF4 standard. The method does so in a consistent, cost effective manner.

Although the present invention has been described with reference to preferred embodiments, persons skilled in the art will recognize that changes may be made in form and detail without departing from the spirit and scope of the invention.

1. A method of manufacturing a lead connector end of an implantable medical lead, the method comprising:
provide a mold cavity including a feature and a longitudinal axis;
place a ring contact in the mold cavity, engaging the ring contact with the feature;
fill the mold cavity with a mold material, the feature preventing displacement of the ring contact along the longitudinal axis;
allow the mold material to cure; and
remove a resulting lead connector end from the mold cavity.

2. The method of claim 1, wherein, when the ring contact is placed in the mold cavity and engaged with the feature, the ring contact includes an excessive outside diameter that exceeds an finished outside diameter of the ring contact when the lead connector end is in a finished state.

3. The method of claim 2, wherein, when the lead connector end is in a finished state, the lead connector end conforms to at least one of an IS4 and DF4standard.

4. The method of claim 2, wherein engaging the ring contact with feature includes causing the feature to engage the outside diameter of the ring contact.

5. The method of claim 2, wherein the mold cavity further includes an inner surface and the feature includes a recess defined in the inner surface.

6. The method of claim 5, wherein the recess is in the form of an arcuate channel.

7. The method of claim 6, wherein the arcuate channel extends in a plane generally transverse to the longitudinal axis.

8. The method of claim 1, further comprising reducing the excessive outside diameter to the finished outside diameter.

9. The method of claim 8, wherein the reducing the excessive outside diameter includes subjecting the resulting lead connector end to a centerless grinding process.

10. The method of claim 1, wherein the mold material includes a polymer.

11. The method of claim 1, wherein the mold material includes at least one of PEEK, tecothane, and polysulfone.

12. The method of claim 1, wherein filling the mold cavity with a mold material includes employing an injection molding process.

13. A method of manufacturing a lead connector end of an implantable medical lead, the method comprising:
provide a ring contact in a mold cavity including a longitudinal axis, the ring contact including an excessive outside diameter that exceeds a finished outside diameter of the lead connector in a finished state;
fill the mold cavity with a mold material, wherein the excessive outside diameter prevents the ring contact from displacing along the longitudinal axis during the filling of the mold cavity;
allow the mold material to cure, resulting in a resulting lead connector end;
remove the resulting lead connector end from the mold cavity; and
subject the resulting lead connector end to a process wherein the excessive outside diameter is reduced to the finished outside diameter.

14. The method of claim 13, wherein the excessive outside diameter prevents the ring contact from displacing along the longitudinal axis by being matingly received in a recess defined in a surface of the mold cavity.

15. The method of claim 14, wherein the recess is in the form of an arcuate channel.

16. The method of claim 15, wherein the arcuate channel extends in a plane generally transverse to the longitudinal axis.

17. The method of claim 13, wherein, when the lead connector end is in a finished state, the lead connector end conforms to at least one of an IS4 and DF4standard.

18. The method of claim 13, wherein the process of reducing the excessive outside diameter includes subjecting the resulting lead connector end to a centerless grinding process.

19. The method of claim 13, wherein the mold material includes a polymer.

20. The method of claim 13, wherein the mold material includes at least one of PEEK, tecothane, and polysulfone.

21. The method of claim 13, wherein filling the mold cavity with a mold material includes employing an injection molding process.

22. A lead connector end manufactured according to the method of claim 13.

23. A lead connector end for an implantable medical lead, the lead connector end comprising:
a cylindrical outer surface including seal region surfaces separating ring contact surfaces in a spaced apart arrangement, the ring contact surfaces being the result of a centerless grinding process.

24. The lead connector end of claim 23, wherein the spaced apart arrangement is the result of a molding process wherein ring contacts corresponding to the ring contact surfaces are secured from displacing along a longitudinal axis of a mold cavity during injection of a mold material corresponding to the seal region surfaces.
